(19) United States
(12) Patent Application Publication
(10) Pub. No.: US 2017/0164091 A1
(43) Pub. Date: Jun. 8, 2017

(54) Electroacoustic Sound Transducer Unit and Earphone

(71) Applicant: Sennheiser electronic GmbH & Co. KG, Wedemark (DE)

(72) Inventor: David Schunack, Burgwedel (DE)

(21) Appl. No.: 15/370,176

(22) Filed: Dec. 6, 2016

(30) Foreign Application Priority Data
Dec. 8, 2015 (DE) 102015121333.8

(51) Int. Cl. H04R 1/10; H04R 9/06

(52) U.S. Cl. CPC H04R 1/1041; H04R 9/063; H04R 1/1075

(57) ABSTRACT

There is provided an electroacoustic sound transducer comprising a diaphragm and at least a first and a second coil coupled to the diaphragm so that the first and second coils can vibrate together with the diaphragm. The electroacoustic sound transducer unit has an impedance switching-over unit for connecting together the at least first and second coils to provide a series circuit or a parallel circuit or for contacting the first coil or the second coil.

The present application claims priority from German Patent Application No. 10 2015 121 333.8 filed on Dec. 8, 2015, the disclosure of which is incorporated herein by reference in its entirety.

### FIELD OF THE INVENTION

It is noted that citation or identification of any document in this application is not an admission that such document is available as prior art to the present invention.

The present invention concerns an electroacoustic sound transducer unit and an earphone.

Electroacoustic sound transducers using the electrodynamic principle have a diaphragm and a vibrating coil which is fixed to the diaphragm and which can vibrate together with the diaphragm. Impedance of an electroacoustic transducer is determined substantially by the vibrating coil. Different impedances are provided for different applications. In particular in the stationary operation of the electroacoustic transducers which are used for example in headphones or headsets a high impedance is required, which causes little loading on the audio source and produces a low distortion factor. In the stationary field of operation the environment is normally quiet so that there is also no need for high volume levels.

When using mobile devices which are also employed outdoors however typically only a low supply voltage for the headphone or the headset is present. This means that the output voltage of the amplifier stages is also limited and thus also the input voltage of the electroacoustic sound transducers. In order nonetheless to be able to make a sufficiently high volume level available they are of low impedance.

Headphones are also known which can be used both for the professional stationary field of operation and also for the professional mobile field and which have a switchable impedance. To achieve that resistors or a transformer are adopted. If however additional resistors are present for matching the impedance in the electrodynamic sound transducer that leads to high power losses, for example of over 80%. Those power losses can occur irrespective of whether the electroacoustic transducer is set to a higher or lower impedance by a series or parallel connection of resistors. If transformers are to be used to match the impedance of the reproduction transducer those components can be both large and also heavy so that they cannot be readily used in a headphone.

In the German patent application from which priority is claimed the German Patent and Trade Mark Office searched the following documents: US 2012/0 257 784 A1, US 2016/0 007 121 A1, EP 1 073 312 A2, WO 2012/022 220 A1 and TW M 488 817 U.

### SUMMARY OF THE INVENTION

An object of the present invention is to provide an electroacoustic reproduction transducer which permits flexible use options.

The invention concerns the notion of providing an electrodynamic sound transducer having a diaphragm and at least two coils coupled to the diaphragm. The impedance of the electrodynamic sound transducer can be matched by a series or parallel connection of the at least two coils. The coils can also be operated individually. In that respect it is to be noted that there are no power losses as in the variant with the additional resistors.

According to an aspect of the present invention the electrodynamic sound transducer has a diaphragm having a first and a second coil. The electrodynamic sound transducer also has a switching-over unit, by means of which the two coils can be electrically operated in a series circuit or in a parallel circuit or each individually. There are therefore four possible options of electrically operating the first and second coils: in a series circuit, in a parallel circuit, only the first coil or only the second coil. In accordance with a further aspect of the invention the switching-over unit is so designed that it allows switching-over between at least two of those four possible options.

If the electrodynamic sound transducer has for example two coils each of 150 ohms then a series connection of the two coils can have a resistance of 300 ohms. A parallel connection of the two coils can have a resistance of 75 ohms. As the two coils are coupled to the diaphragm the entire vibrating coil is always in operation so that the power factor (the BI values of the magnetic drive) is maintained. In addition no power losses due to the switching-over action occur. Moreover the acoustic properties are not affected as the mechanical structure does not change.

According to a further aspect of the present invention the two vibrating coils can be coupled to the same diaphragm. Optionally the two vibrating coils can be jointly wound. They can be mechanically connected together and are jointly coupled to the diaphragm by way of a common mechanical connection.

In accordance with a further aspect of the present invention the two vibrating coils are each of an impedance of 300 ohms so that an impedance of 600 ohms can be achieved by series connection and an impedance of 150 ohms can be achieved by parallel connection.

According to a further aspect of the present invention the two vibrating coils can be of differing impedances. For example the first vibrating coil can be of an impedance of 400 ohms and the second vibrating coil an impedance of 200 ohms. The series connection then has an impedance of 600 ohms while the parallel connection has an impedance of about 133 ohms. In accordance with this example therefore it is possible to make a selection between four different impedance values for operation of the sound transducer, by suitable connection by means of the switching-over unit.

Optionally the switching-over unit can be operable by a user. For that purpose a switch can be provided at an electrodynamic sound transducer in such a way that the user can perform the switching-over operation himself. Automatic switching-over can optionally be implemented.

It should further be noted that the acoustic properties are maintained by switching over between a series and a parallel connection. Switching-over only has an influence on the acoustic pressure level which can change with the same input voltage by 6 dB.

In accordance with an aspect of the present invention an earpiece, a headphone, an earphone or a headset can be provided with two electrodynamic sound transducers designed according to the invention, wherein a respective one of the two sound transducers is associated with an ear of a user. Both sound transducers are then provided with two respective vibrating coils coupled to a respective common diaphragm. In addition a switching-over unit is associated with each of the two sound transducers. The user can therefore select the respective impedance of one of the two sound transducers by way of the two switching-over units.

As an alternative thereto only one switching-over unit can be associated with the two electrodynamic sound transducers for jointly switching over both electrodynamic sound transducers.

According to an aspect of the present invention the impedance of the first coil can differ from that of the second coil. It is thus possible to achieve switching-over factors of other than 0.5 and 2.

In this respect however it is to be noted that the installation space for the vibrating coil in the air gap of the magnetic driver is limited and should preferably be put to optimum use. Thus the diameters of the wires for the vibrating coils cannot be freely selected but are limited by the available winding space. Accordingly the load capacity of the low-impedance coil can fall if the ratio is no longer 1:1.

If for example a transducer with a first vibrating coil involving 75 ohms and a second vibrating coil involving 225 ohms is used, which corresponds to a ratio of 1:3, then an impedance of 300 ohms can be achieved by a series connection and an impedance of 56.25 ohms by a parallel connection.

In the parallel mode however the power is inversely proportional to the impedance so that three times more power is also converted at the low-impedance coil. Accordingly the power which can be supplied falls and therewith the volume which can be achieved in a parallel connection (low impedance). Depending on the respective diameter used for the wires for the vibrating coil therefore it is possible with certain ratios to reach a point at which the advantage of a low impedance no longer affords an increase in volume because of the limited power consumption.

The invention also concerns an earphone comprising at least one electrodynamic sound transducer which has a diaphragm and two coils connected to the diaphragm. The earphone can have an active noise cancelling unit and a microphone for detecting outside noise for active noise cancellation. Active noise cancellation provides that, based on the detected outside sound, a cancellation signal is generated which is reproduced together with the audio signal to be reproduced on or by way of the electroacoustic sound transducers. According to the invention one coil is adapted to reproduce an audio signal while the other coil is provided for reproducing a cancellation signal or cancellation sound which serves to reduce the detected noise.

### BRIEF DESCRIPTION OF THE DRAWINGS

FIG. 1 shows a diagrammatic view of an electroacoustic sound transducer unit according to a first embodiment.

FIG. 2 shows a diagrammatic view of an electroacoustic sound transducer unit according to a second embodiment.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

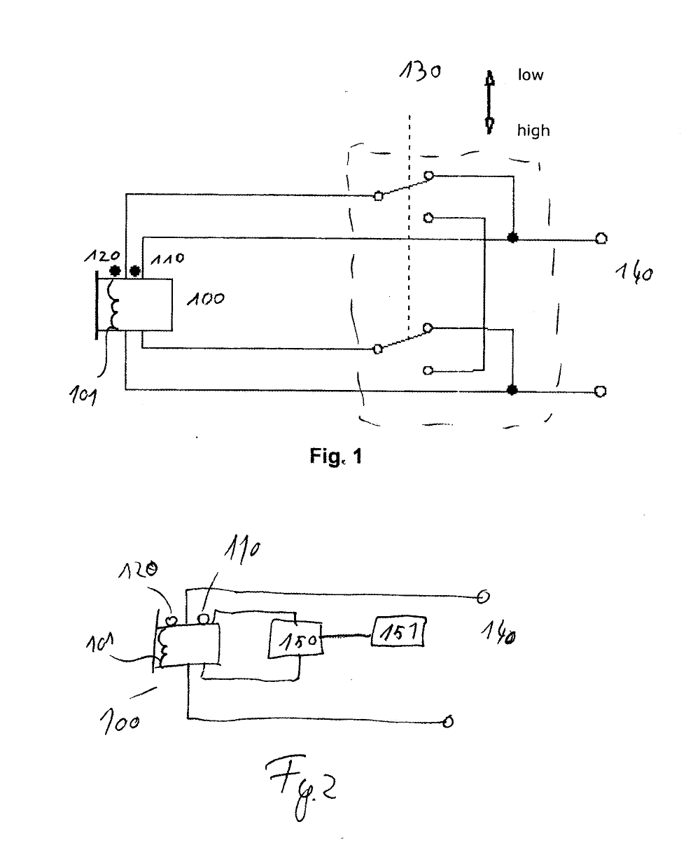

FIG. 1 shows a diagrammatic view of an electroacoustic sound transducer unit according to a first embodiment. The electroacoustic sound transducer unit 100 has a first and a second coil 110, 120 which act on a diaphragm 101 of the transducer 100. The first and second coils 110, 120 are both coupled independently of each other to the diaphragm 101 so that they vibrate synchronously.

The electroacoustic sound transducer unit 100 further has a switching unit 130 by means of which only the first coil 110, only the second coil 120, a series connection of the first and second coils 110, 120 or a parallel connection of the first and second coils 110, 120 can be provided. The switching-over unit 130 can be used for impedance switching. When the two coils 110, 120 are connected in series (both switching-over devices in the position “high”) then the output impedance 140 corresponds to the total of the impedances of the first and second coils 110, 120. If the first and second coils are connected in parallel (both switching-over devices in the position “low”) then the output impedance 140 corresponds to a 0.5 impedance of the first and second coils 110, 120 insofar as the first and second coils have the same impedance. According to the invention therefore impedance matching of the electroacoustic sound transducer unit 100 can be achieved by the switching-over unit 130.

In the cases in which both coils are active (series and parallel connection) then both coils are connected with polarities such that the winding direction is in-phase. That is indicated in FIG. 1 by the two black dots at the sound transducer unit 100. That provides that both coils 110 and 120 have current flowing therethrough in the magnetic field in the same direction and thus the drive force is added at the diaphragm 101.

The broken line in FIG. 1 between the two parts of the switching-over unit 130 (each respective switching-over device) indicates that the two parts are coupled. The two switching-over devices are therefore either in the upper or in the lower position. It is therefore possible to choose only between the two settings “series connection” and “parallel connection”.

If in contrast the two switching-over devices of the switching unit 130 remain uncoupled and accordingly can also be actuated individually it is then possible to provide for two further settings. If the upper switching-over device is in the upper position and the lower one is in the lower position then only the second coil 120 is in operation. The impedance of the earphone is defined by the value that the coil 120 alone has. If in contrast the upper switching device is in the lower position while the lower one is in the upper position then only the first coil 110 is in operation. The impedance of the earphone is thus the value that the coil 110 alone has. In both cases only one coil drives the diaphragm; the efficiency of the earphone is lower in those cases as the non-active coil must be also moved by the drive force of the other (moved mass increases). If however a given impedance is wanted for the earphone it may however be the case that this slight disadvantage is tolerated in return. Although in the first embodiment two coils have been described it is also possible in accordance with an aspect of the present invention for more than two coils to be coupled to the diaphragm 101 of the transducer in such a way that they jointly vibrate.

The switching-over unit then has to be suitably adapted to be able to implement series or parallel connection of the multiplicity of coils.

FIG. 2 shows a diagrammatic view of an electroacoustic sound transducer unit according to a second embodiment. The electroacoustic sound transducer unit of the second embodiment has a diaphragm 101 and at least two coils 110, 120 which are so coupled to the diaphragm that they can vibrate therewith. The electroacoustic sound transducer unit or an earphone according to the second embodiment has an active noise cancellation unit 150 which detects interference sound by means of a microphone 151 and generates a cancellation signal which is output for example to the first coil 110 so that the first coil 110 correspondingly excites the diaphragm 101. In addition thereto an audio signal to be reproduced can be received by the earphone by way of the input 140 and passed to the second coil 120 so that the second coil 120 correspondingly excites the diaphragm 101. According to the second embodiment the first coil 110 has a low impedance in order to be able to compensate for even high interference levels in non-lossy fashion. Therefore the impedance of the first coil 110 is between 150 and 600 ohms. According to the second embodiment of the invention summing of the input signal and the cancellation signal is effected by the active noise cancellation unit 150 (not electronically as hitherto) but acoustically by way of the diaphragm 101. That has the advantage that the impedance of the first coil 110 can be matched to the demands of the active noise cancellation unit and the impedance of the second coil 120 can be matched to the demands of reproduction of the audio signal to be reproduced.

Such noise-cancelled earphones (or when including a microphone in the form of headsets) are widely used both in the consumer and also in the professional field. Thus for example the property of noise reduction is highly valued by pilots. In that case the function of the actual earphone has to be consistently guaranteed (radio communication). That is precisely to apply even in the event of failure of noise cancellation (for example because of an inadequate power supply to same): the normal function of the headphone may not be impaired thereby (so-called “fail safe” performance).

In previously known circuits for that purpose in the noise cancellation unit the environmental noise picked up by the microphone and also the audio signal to be reproduced for the earphone are jointly processed and applied to a single coil of the headphone. Upon failure of noise cancellation the audio signal to be reproduced must be passed directly to the single coil of the headphone. Here therefore switching-over is required, which without an adequate power supply for the noise cancellation unit supplies the headphone with the original input signal, but when noise cancellation is operating however it is supplied with the output signal of the noise cancellation unit. Nowadays usually so-called FET switches (=field effect transistors) are used for that switching-over action. Earlier there were also configurations with relays.

If in contrast an arrangement according to the invention as shown in FIG. 2 is used then various problems do not arise at all: as volume compensation and the audio signal to be reproduced are passed separately to a respective dedicated coil the FETs for switching over can be omitted. Faults which can occur due to the switching-over action are thus excluded. The switching-over unit itself can be completely spared (costs) and the switching-over unit so longer uses any power. The latter is found to be a positive precisely in the situations in which that unit is battery-powered as it prolongs the battery life.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. An electroacoustic sound transducer unit (100) comprising:
a diaphragm;
at least a first coil and a second coil which are each mechanically coupled to the diaphragm so that the first coil and the second coil vibrate together with the diaphragm; and
an impedance switching-over unit configured to set an electrical output impedance of the sound transducer unit by electrically connecting the at least first and second coils;
wherein the impedance switching-over unit further configured to switch over between at least two of the following four possible options:
series connection of the first and second coils;
parallel connection of the first and second coils;
connection only of the first coil; and
connection only of the second coil.

2. The electroacoustic sound transducer unit as set forth in claim 1:
wherein an impedance of the first coil corresponds to an impedance of the second coil.

3. The electroacoustic sound transducer unit as set forth in claim 1:
wherein an impedance of the first coil is different from an impedance of the second coil.

4 An earphone or headset comprising:
at least one electroacoustic sound transducer unit as set forth in claim 1;
wherein the impedance switching-over unit is configured to be operated by a user.

5. An earphone or headset comprising:
an electroacoustic sound transducer having:
a diaphragm; and
at least a first coil and a second coil which are each mechanically coupled to the diaphragm so that the first coil and the second coil vibrate together with the diaphragm; and
an active noise cancellation unit that, based on at least one interference sound detected by a microphone, generates a cancellation signal that is output by way of the first coil;
wherein an audio signal to be reproduced is reproduced by way of the second coil.

6. Earphones or a headset comprising:
two electroacoustic sound transducer units as set forth in claim 1;
wherein a respective one of the sound transducer units is associated with a respective ear of a user.

7. The earphones or headset as set forth in claim 6:
wherein the impedance switching-over units of the two sound transducer units are configured to effect joint switching-over of the output impedances of the two sound transducer units.
